(19) United States
(12) Patent Application Publication
(10) Pub. No.: US 2012/0224172 A1
(43) Pub. Date: Sep. 6, 2012

(54) Optical components for use in measuring projection lens distortion or focus of an optical imaging system that images a substrate

(75) Inventors: Eric Peter Goodwin, Tucson, AZ (US); Daniel Gene Smith, Tucson, AZ (US); David Michael Williamson, Tucson, AZ (US); Takamitsu Sugawara, Kumagaya (JP); Yasuhiro Kitamura, Fukaya (JP)

(73) Assignee: Nikon Corporation, Tokyo (JP)

(21) Appl. No.: 13/315,592

(22) Filed: Dec. 9, 2011

Related U.S. Application Data
(60) Provisional application No. 61/459,318, filed on Dec. 10, 2010.

(51) Int. Cl. G01N 21/17

(52) U.S. Cl. 356/124

(57) ABSTRACT

New and useful optical components are provided, for use in measuring projection lens characteristics of an optical imaging system that images a substrate. The optical components comprise an array of full NA imagers located at the substrate plane, and a relay system for imaging the imagers to a detector that is remote from the substrate.

### RELATED APPLICATION/CLAIM OF PRIORITY

This application is related to and claims priority from provisional application Ser. No. 61/459,318, filed Dec. 10, 2010, which provisional application is incorporated by reference herein.

### INTRODUCTION

The present invention provides Optical components for use in measuring projection lens characteristics (e.g. projection lens focus or distortion) of an optical imaging system that images a substrate. The optical components comprise an array of full NA (preferably small field) imagers located at the substrate plane, and a relay system for imaging the output from the imagers to a detector that is remote from the substrate.

Due to the high performance required of high end projection optics (e.g. for lithographic imaging of a substrate in the production of a semi conductor wafer), it is important to be able to measure various properties of the projection lens to a high level of accuracy and as close to the condition in which the lens will be used in printing (imaging the substrate). In order to not limit throughput of the imaging system, this measurement should be done quickly and accurately. Part of increasing the speed of the measurement is to measure as many points in the field (typically 26×5 mm) in parallel as possible.

It is also important to measure light from as many points in the projection lens pupil as possible. For example, measuring focus using light within an NA significantly less than the full NA of the projection lens does not always accurately capture the actual focal plane (or distortion information). Many lithography processes utilize light at the edge of the pupil, such as dipole illumination, in which case a focus measurement with light under NA of 0.6 (for a full NA of 1.3 projection lens) can be very misleading.

High NA projection optics immerse the substrate in water or other fluids to increase the NA; hence the name immersion lithography. Some schemes proposed in the past involve using fluorescent materials to convert the 193 nm light to visible light, which can be transferred to a detector via an array of fibers called a fiber optic plate (FOP). This technique has been demonstrated in dry systems, but the lifetime of fluorescent materials while immersed is not likely to be very good. Another issue is that placing a detector such as a charge couple device (CCD) or other detector element on the substrate stage requires many cables (data, power, cooling), and such a system generates heat. The heat can cause thermal non-uniformities of the substrate stage that lead to printing (imaging) errors.

### SUMMARY OF THE PRESENT INVENTION

The present invention is designed to address the foregoing issues. The present invention provides a new and useful optical component for measuring projection lens characteristics by imaging the full NA of the projection lens. Additionally, the present invention provides additional optics for imaging the optical component to a detector located remote from the substrate.

The new optical component that measures projection lens characteristics is characterized by an array of two or more full NA imagers located at the substrate plane.

Preferably, each of the full NA imagers has a catadioptric optical configuration with a pair of reflecting surfaces, and a refracting region that transmits light that is imaged to the detector.

The detailed description below provides two exemplary configurations for the full NA imagers.

In one configuration, each of the full NA imagers comprises a reflecting surface that has a predetermined curvature and a refracting region having a curvature with an opposite direction to the curvature of the reflecting region. The refracting region is located at the center of the curved reflecting surface.

In another configuration, each of the full NA imagers comprises a refracting region configured to refract and transmit light below a predetermined threshold angle of incidence. Each of the full NA imagers further comprises a relatively flat reflecting surface that faces the curved reflecting surface, where the curvature of the curved reflecting surface and the orientation of the curved and relatively flat reflecting surfaces are configured to produce reflection of light rays above a predetermined first threshold angle of incidence, and reflect the light rays in a manner that produces reflected light rays that are directed to the refracting region at angles of incidence below the second threshold angle of incidence. Such light rays are refracted and transmitted by the refracting region. Preferably, the curved reflecting surface comprises a reflective portion of a continuous curved surface, and the refracting portion comprises a refracting portion of the continuous curved surface. The continuous curved surface has a surface coating that reflects light incident above the first threshold angle of incidence, and has a refracting region that refracts and transmits light below the second threshold angle of incidence. There is some transition region, or range of angles, below the first threshold angle and above the second threshold angle where no light should be incident on the surface, in accordance with the design of the imager.

When the optical component is part of a full system for measuring projection lens characteristics, the array of full NA imagers are located at the substrate plane, and additional optics are provided for imaging the array of imagers to a detector located remote from the substrate. Preferably, the additional optics are configured to image the output of the array of imagers (described herein as the intermediate image plane) to a detector that is remote from the substrate.

Also, the full NA optical imagers are arranged in a predetermined configuration at the substrate plane. Each element of the array of the full NA imagers is preferably cylindrical and the elements of the array of full NA imagers are in a configuration in which the centers of the cylindrical imagers form a rectangle of about 26 mm by 5 mm.

Further features of the present invention will be apparent from the following detailed description and the accompanying drawings.

### BRIEF DESCRIPTION OF THE DRAWINGS

FIG. 1 is a schematic illustration of the components of an optical imaging system, with which the present invention is useful;

FIG. 2 is a schematic three dimensional illustration of an array of full NA imagers, in accordance with the present invention;

FIG. 3 is a schematic top view of the array of full NA imagers of FIG. 2;

FIG. 4 is a schematic illustration of the relative proportions and the manner in which each full NA imager measures information about the projection lens;

FIGS. 5a and 5b are schematic illustrations of the reflecting and refracting aspects of each of the full NA imagers, according to one version of the present invention;

FIG. 6 is a schematic illustration of the optical components of a system from which the full NA imagers produce an intermediate image that is then imaged to a detector located remote from the substrate;

FIG. 7 is a schematic enlarged illustration of certain aspects of the optical relay, according to the present invention;

FIG. 8 is a schematic illustration of the manner in which the optical imagers of FIGS. 2-4 can be formed;

FIG. 9 is a schematic illustration of the reflecting and refracting aspects of full NA imagers, according to another version of the present invention;

FIGS. 10a, 10b and 10c are schematic illustrations that show additional features of the full NA imagers shown in FIG. 9; and

FIG. 11 is a schematic illustration of the manner in which the full NA imagers of FIG. 9 can be formed.

### DETAILED DESCRIPTION

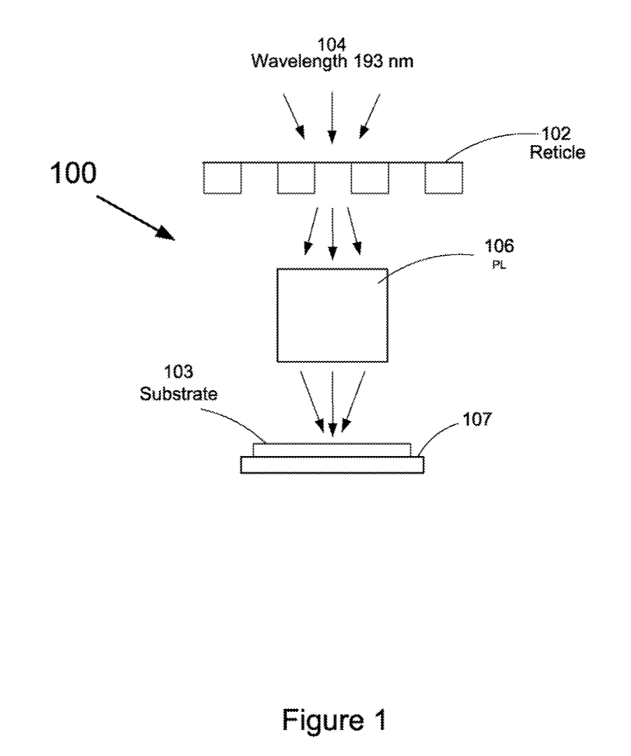

FIG. 1 is a schematic illustration of an optical imaging system with which the present invention is useful. The optical imaging system 100 includes a light source 104 that can be, e.g. an Argon Fluoride (ArF) laser that produces light in a 193 nm wavelength range. The light illuminates a mask or reticle 102 that has a portion of a circuit thereon, and the illumination of the reticle is project to a substrate 103 by a projection lens 106. The substrate 103 is supported on a stage 107 that is moveable relative to the projection lens 106 as the substrate 103 is being imaged. The projected image of the reticle exposes selected areas of a resist on the substrate, in accordance with the pattern on the reticle, and those selected areas are then used in producing on the substrate a portion of a circuit that is used in forming a semi conductor wafer. The system 100 is referred to as an immersion lithography system, because the image of the reticle is projected to the substrate 103 through a liquid layer located between the projection lens and the substrate.

As explained above, due to the high performance required of high end projection optics (e.g. for lithographic imaging of a substrate in the production of a semi conductor wafer), it is important to be able to measure various properties of the projection lens 106 to a high level of accuracy and as close to the condition in which the lens will be used in printing (imaging) the substrate 103. In order to not limit throughput of the optical imaging system, this measurement should be done quickly and accurately. Part of increasing the speed of the measurement is to measure as many points in the field of the projection lens (typically 26×5 mm) in parallel as possible.

It is also important to measure light from as many points in the projection lens pupil as possible. For example, measuring focus using light within a numerical aperture (NA) significantly less than the full NA of the projection lens does not always accurately capture the actual focal plane (or distortion information). Many lithography processes utilize light at the edge of the pupil, such as dipole illumination, in which case a focus measurement with light under NA of 0.6 (for projection lens with a full NA of 1.3) can be very misleading.

High NA projection optics immerse the substrate in water or other fluids to increase the NA; hence the name immersion lithography. Some schemes proposed in the past involve using fluorescent materials to convert the 193 nm light to visible light, which can be transferred to a detector via an array of fibers called a fiber optic plate (FOP). This technique has been demonstrated in dry systems, but the lifetime of fluorescent materials while immersed is not likely to be very good. Another issue is that placing a detector such as a charge couple device (CCD) or other detector element on the substrate stage (which is a moveable support upon which the substrate is supported as it is being imaged) requires many cables (data, power, cooling), and such a system generates heat. The heat can cause thermal non-uniformities of the substrate stage that lead to printing (imaging) errors.

The present invention is designed to address the foregoing issues. The present invention provides a new and useful optical component for measuring projection lens characteristics by imaging the full NA of the projection lens 106. Additionally, the present invention provides additional optics for imaging the optical component to a detector located remote from the substrate.

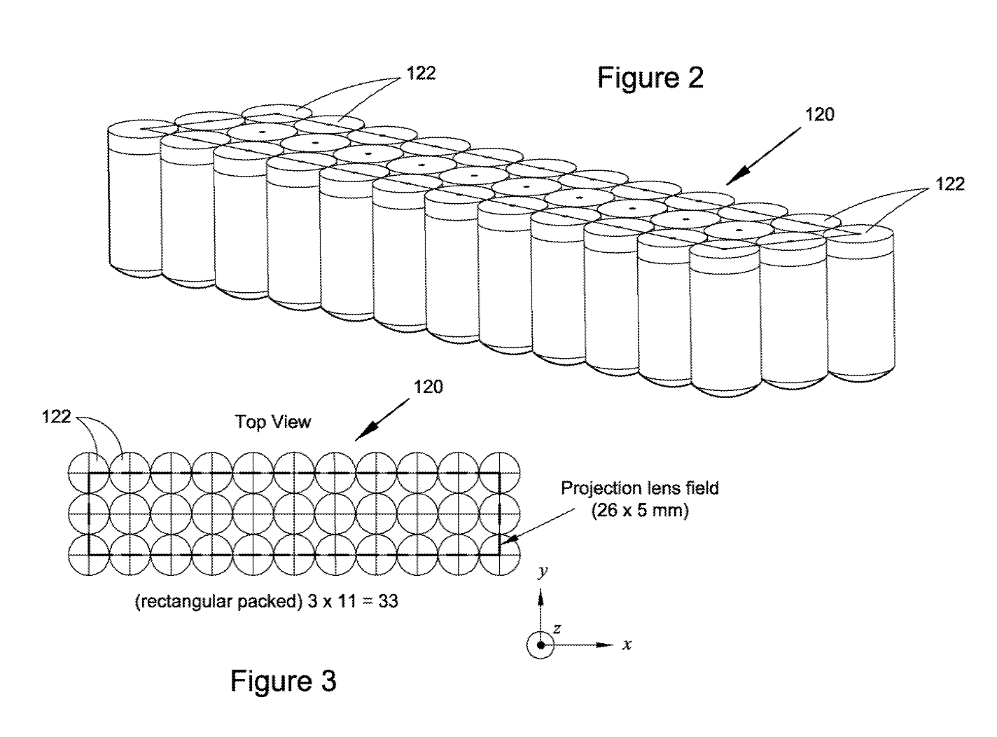

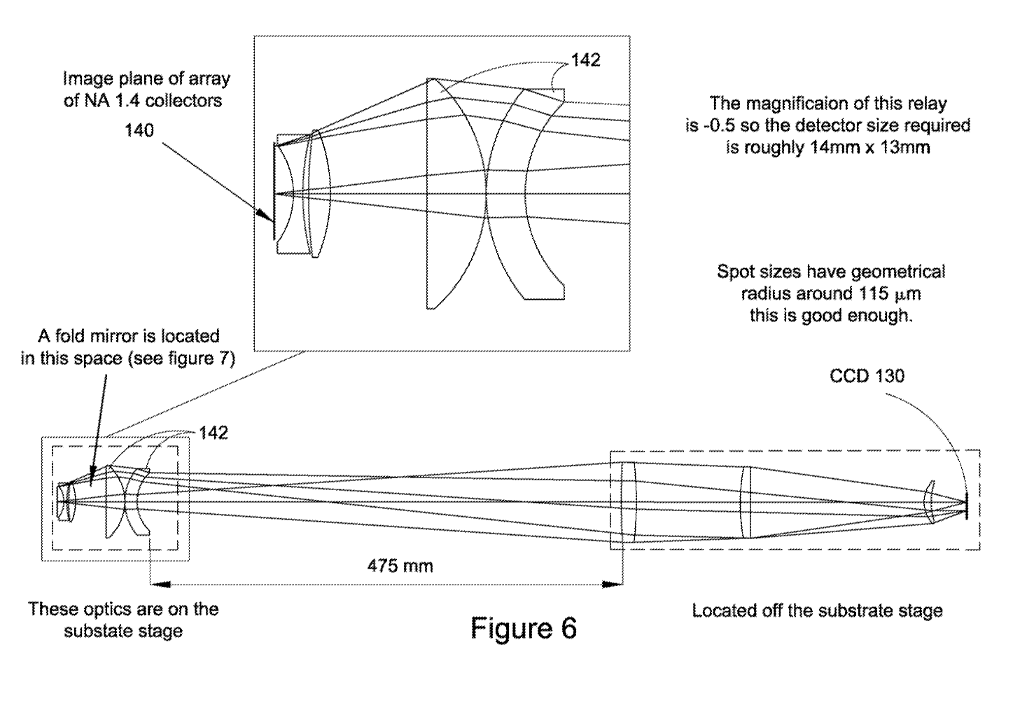

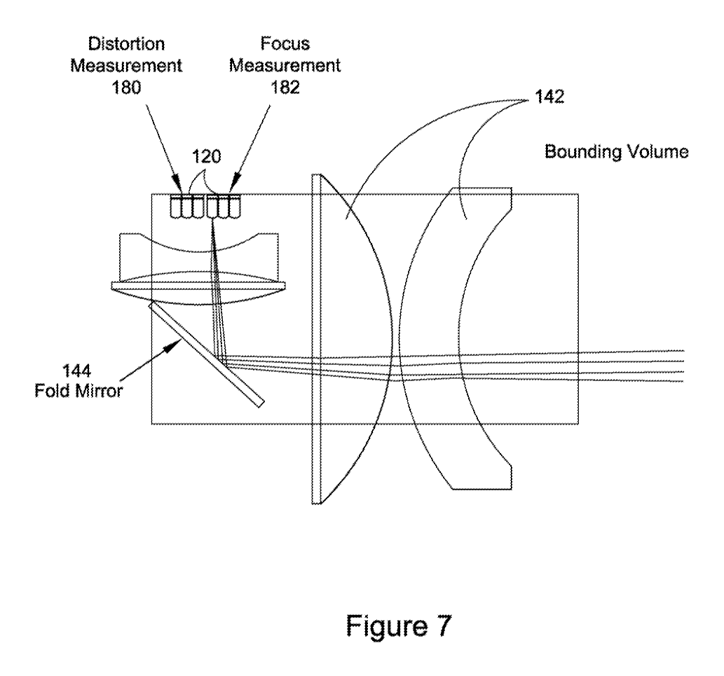

FIGS. 2-4, 5a and 5b show the configuration of a new optical component 120 in accordance with the present invention. The new optical component 120 measures projection lens characteristics and is characterized by an array of two or more full NA imagers 122 located at the substrate plane. The new optical component 120 can be supported on a portion of the stage 107 that supports the substrate 103 (see FIG. 6).

As shown in FIGS. 2-4, 5a and 5b, each of the full NA imagers 122 is cylindrical in configuration, and has a catadioptric optical configuration with a pair of reflecting regions 124, 126, and a refracting region 128 that transmits light that is directed to a detector 130 (e.g. a charge couple device, or CCD) that is located remote from the substrate 103 and the stage 107 (see FIG. 6).

In the configuration shown in FIGS. 2-4, 5a and 5b, each of the full NA imagers 122 comprises a flat reflecting region 124 and a curved reflecting region 126 (that has a predetermined curvature) and a refracting region 128 (formed by refracting optics 128a, that in the illustrated embodiment comprise a refractive body of air) that are located in a curved, transmissive region 128b at the center of the curved reflecting region 126). The curved transmissive region 128b has a curvature that is opposite to the curvature of the reflecting region 126, in the sense that the curved reflecting region has a concave orientation relative to the flat reflecting region 124, and the curved transmissive region 128b has a convex orientation relative to the flat reflecting region 124.

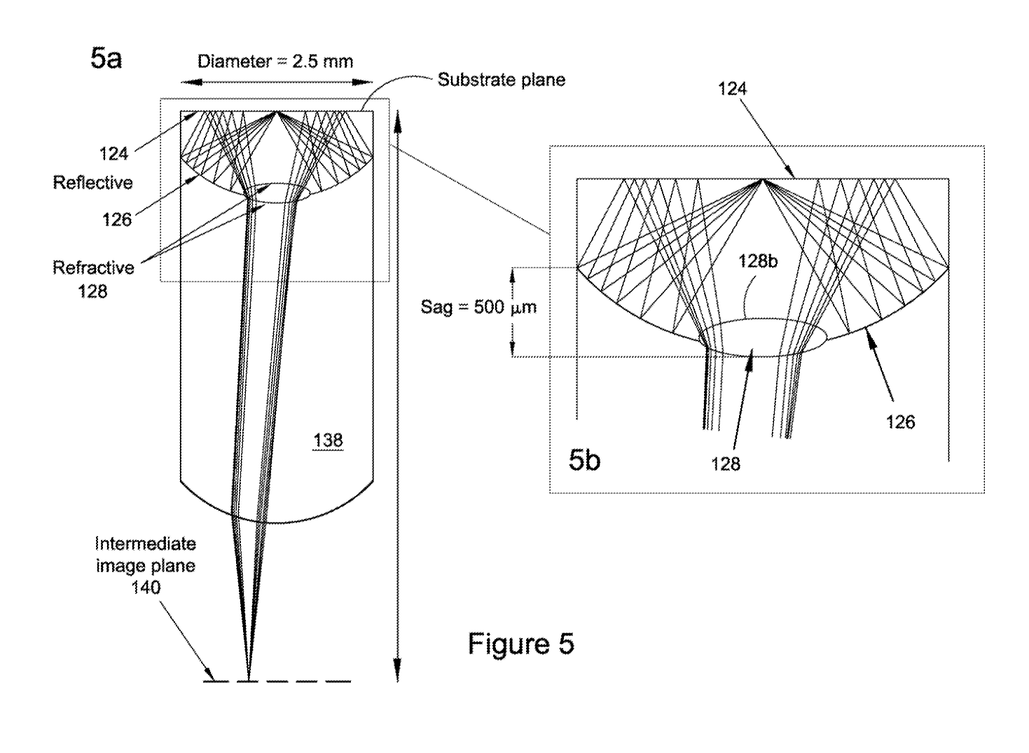

With the configuration of FIGS. 2-4, 5a and 5b, each full NA imager 122 has a bounding area 132 with a central field 133 that captures 4 regions 136 of the projection lens (as shown in FIG. 4). In one example for measuring distortion, each of the 4 regions 136 includes a blinker array 134 (of a known type, as described below), where the blinker array 134 for 2 of the regions 136 would be in one direction and the blinker array for the other 2 regions would be in another direction. Light from each region 136 enters the full NA imager 122 at the full NA of the system, and illuminates the blinkers 134 associated with that region. That light is reflected by the curved reflecting region 126 and then by the flat reflecting region 124. The reflection from the flat reflecting region 124 causes the light to be directed to the refractive region 128 where the light is refracted and transmitted by the refractive region. That light is directed through a lens element 138 of the full NA imager 122 and to an intermediate image plane 140 associated with the array of imagers 122.

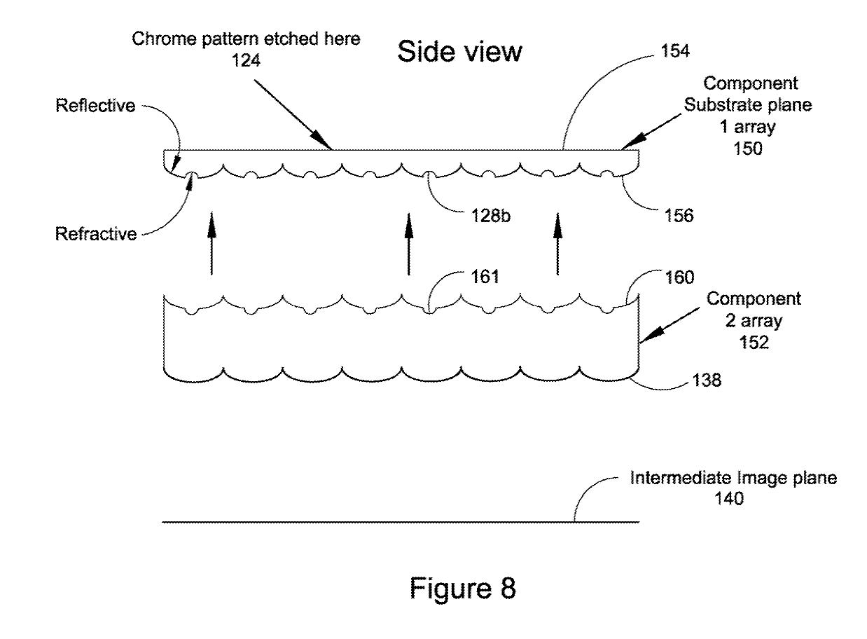

As shown by FIGS. 6 and 7, the intermediate image plane 140 is imaged to the CCD detector 130. Light from the intermediate image plane 140 is directed to the detector 130 through one or more optics 142 and the light is bent by a fold mirror 144, so that the intermediate image plane 140 is thereby imaged to the CCD detector 130 which is remote from the substrate 103 and the stage 107. Thus, the full NA image captured by each of the imagers 122 is directed to the intermediate image plane 140 and is then imaged to the detector 130. That imaging schema, particularly with blinker arrays 134 oriented in different directions, provides information about the projection lens (e.g. focus information and/or distortion information). Specifically, the blinkers convert the information (i.e. distortion) into irradiance at the substrate plane. The full NA imagers 122 relay this irradiance to the intermediate image plane 140, where the four regions 136 indicated in FIG. 4 are fully resolved, i.e. the light from the blinkers associated with each region 136 is separate from the light from all other blinkers (which are associated with different regions 136). The relay system maintains this separation when projecting the irradiance to the CCD detector 130. By comparing the relative irradiance of the four blinker regions 136 (FIG. 4) associated with a single full NA imager 122, the distortion in x and y can be obtained at each full NA imager. Since there are multiple full NA imagers at different field points in the substrate plane, a distortion map across the field can be measured by comparing the distortion information obtained from each full NA imager. A different pattern at the substrate plane can lead to the measurement of focus in a similar way. Yet another pattern could be used to determine certain lens aberrations as well, as described further below.

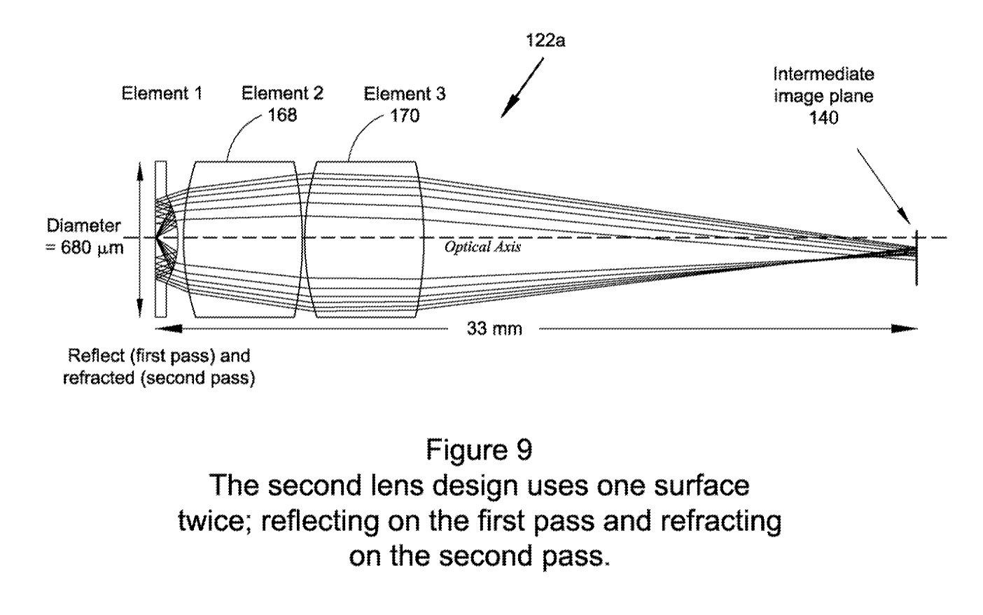

FIG. 8 shows schematically a way to produce the array of full NA imagers shown in FIGS. 2-4, 5a and 5b. The array of full NA imagers is formed from two components 150, 152 that are fit together to form the entire array of full NA imagers 122. The component 150 is formed of glass and includes a flat region 154 with a reflecting surface. That flat reflecting surface forms the flat reflecting regions 124 of the full NA imagers 122. The component 150 also has curved surface profiles 156 that have a reflective coating and form the curved reflecting regions 126. The transmissive portions 128b of the refracting regions 128 are located substantially at the centers of the curved reflecting regions 126. Also, as can be seen from FIG. 8, the transmissive portions 128b extend from the surface profiles 156, so that the surface profiles 156 and the transmissive portions 128b are contiguous with each other.

The other component 152 is also formed of glass and has a surface configuration 160 on one side that conforms to the surface profiles 156, and additional surface configurations 161 that co-operate with the transmissive regions 128b to capture the refracting optics 128a (e.g. the refractive volume of air) that complete the refracting regions 128. In addition, the glass component 152 also forms the lens element 138 of the full NA imagers 122, which direct refracted light to the intermediate image plane 140.

As an example, as shown in FIG. 8, the component 150 can be formed from a >1.2 mm thick glass plate, at least 27.5 mm×7.5 mm (preferably larger). The substrate side of that glass plate can be polished to the desired flatness, in forming the flat reflecting region 124. Using ion beam etching (possibly preceded by rough polishing), the array of curved surfaces forming the curved surface profiles 156 can be made and then coated with the appropriate reflective coating. The central transmissive portions 128b that form the refracting regions 128 can then be created using ion-beam etching. The chrome pattern can be deposited on the substrate side in the pattern desired for whatever this device will be used to measure (i.e. blinkers for distortion measurement). The second component 152 is made in a similar fashion, although two curved surface arrays are required but there is no additional chrome patterning.

The two glass components 150, 152 can be pressed together mechanically (with the air volume forming the refractive optics 128a located between the transmissive portions 128b and the surface profiles 156), creating the final form of the full NA imagers 122. The final result is a nearly solid glass plate, e.g. with dimensions of 5 mm height, 7.5 mm depth and 27.5 mm wide, minimum, that has sufficient mechanical stability to provide the entire array of full NA imagers 122.

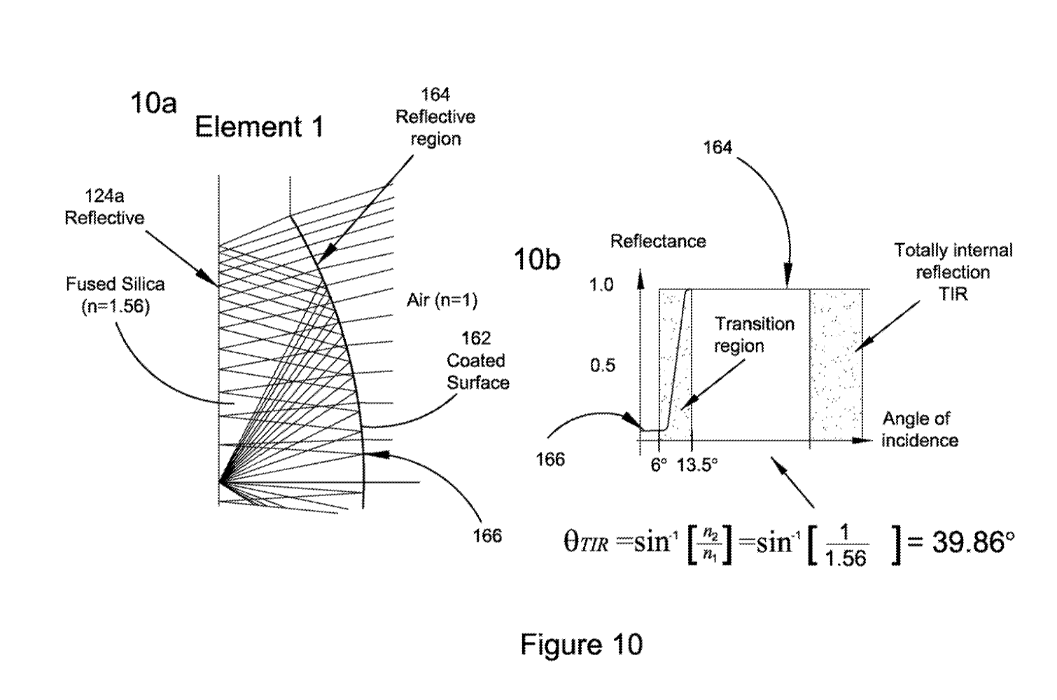

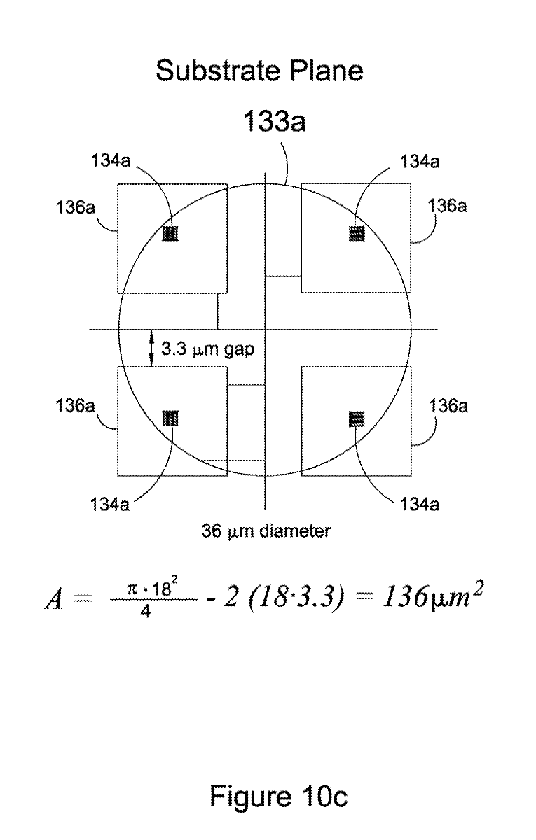

In another configuration, shown in FIGS. 9, 10a-10c and 11, each of the full NA imagers 122a comprises a substantially continuous curved surface 162 with a single coating that simultaneously produces the curved reflecting region 164, and the transmissive, refracting region 166 located substantially at the center of the curved reflecting region 164. The surface coating on the continuous surface 162 is configured to refract and transmit light below a predetermined second threshold angle of incidence, and the surface coating will reflect light above the predetermined first threshold angle of incidence. The second threshold angle of incidence is taken relative to a surface normal to the curved refracting region 166, and is lower than the first threshold angle of incidence. Each of the full NA imagers 122a further comprises a relatively flat reflecting region 124a that faces the curved reflecting region 164 and the refracting region 166. The curvature of the curved reflecting region 164 and the orientation of the curved and relatively flat reflecting regions 164, 124a are configured to produce light rays that are directed to the refracting region 166 at angles of incidence below the second threshold angle of incidence. Thus, the reflecting and refraction regions are formed from the continuous curved surface 162, with a coating that provides the curved reflecting region 164 that reflects light at angles of incidence above the first threshold level, and the refracting region 166 that refracts at angles of incidence below the second threshold level. An example of the reflective and refractive characteristics of the coating is shown, e.g. in FIG. 10b.

Each of the full NA imagers 122a of FIGS. 9, 10a-10c and 11 includes a pair of glass transmissive elements 168, 170 that direct the refracted light to an intermediate image plane 140. That intermediate plane is imaged to a detector 130, in the same way as shown in FIGS. 6 and 7. In addition, each of the full NA imagers 122a has a central field 133a that captures 4 regions 136a of the projection lens, each of which has a blinker array 134a (as shown in FIG. 10c). As with the version of FIGS. 1-8, the blinker arrays 134a have different orientations.

With the full NA imagers of FIGS. 9, 10a-10c and 11, the continuous surface 162 is effectively used twice. The steeply curved portion of the continuous surface forms the reflective region 164 that reflects light on the first pass and the refracting region 166 that refracts on the second pass. As an example, the steeply curved reflecting region 164 reflects light that has an angle of incidence between 13.5 degrees and 43 degrees, and the light on the second pass, which has an angle of incidence of less than 6 degrees, is transmitted and refracted by the refracting region 166. FIG. 9b shows an example of how the surface coating provides such reflection and refraction characteristics. In this example, the first threshold angle is 13.5 degrees, and the second threshold angle is 6 degrees, and the transition region extends from 6 to 13.5 degrees.

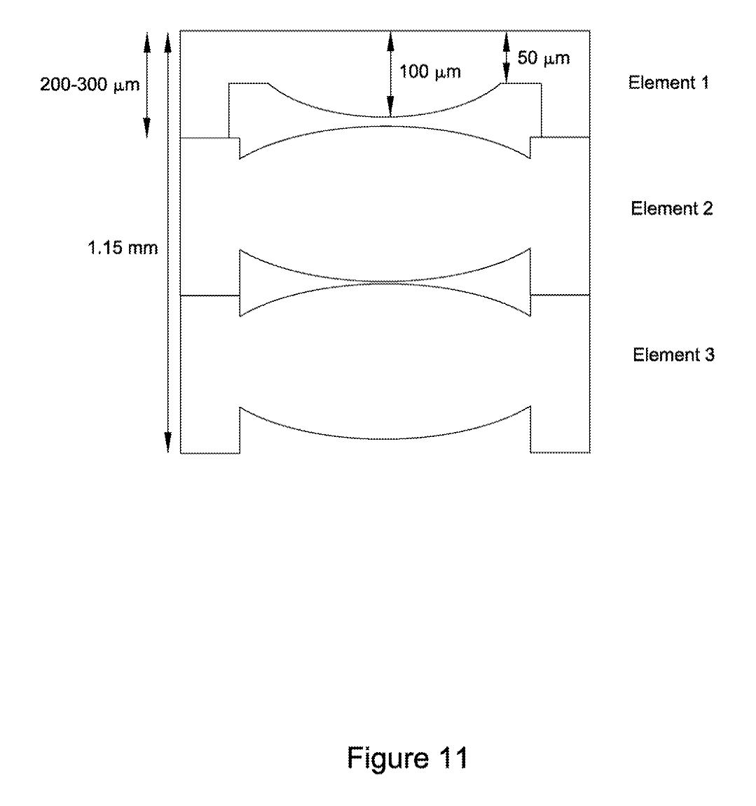

FIG. 11 shows what is believed to be an improved fabrication technique for the full NA imagers 122a. Each imager 122a is formed by 3 elements (identified as elements 1, 2 and 3) that are etched glass elements that are coupled together to form the imager. Element 1 forms the flat surface that forms the flat reflecting region 124a and also forms the continuous surface 162 that is used in forming the reflecting and refracting regions 164 and 166. Elements 2 and 3 form the glass sections (i.e. lens elements) 168, 170 that transmit the refracted image to the intermediate plane 140. The configuration of the three elements allows the etch process to create a mechanical structure that allows the full NA imagers 122a to be more easily mounted together.

As will be appreciated from the foregoing description, with either of the foregoing versions, when the array of full NA imagers are part of a full system for measuring projection lens characteristics, the array of full NA imagers are located at the substrate plane (i.e. the plane that encompasses the substrate 103), the additional optics (e.g. the lens element 138 or the pair of glass elements 168, 170) direct the light to the intermediate image plane 140, and the relay components (e.g. the optics 142 and the fold mirror 144) image the intermediate image plane 140 to the CCD detector 130 located remote from the substrate 103 and the stage 107.

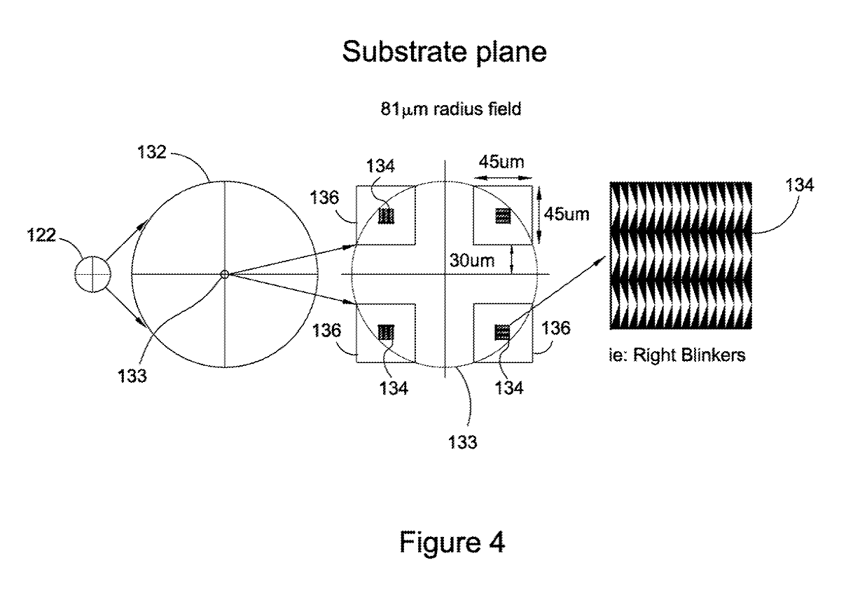

Also, the full NA imagers are arranged in a predetermined configuration at the substrate plane. For example, as illustrated in FIGS. 2 and 3, each of the array of the full NA imagers 122 is preferably cylindrical and the array of full NA imagers are in a configuration in which the centers of the cylindrical imagers form a rectangle of about 26 mm by 5 mm (see e.g. FIG. 3).

With the optical components described herein, it will be clear to those in the art that the full NA imagers capture the full NA of light incident at the substrate plane (up to 1.4 in a system currently under investigation). Multiple points are captured within the projection optics field simultaneously. For example, a bounding region 132 that is about 162 um in diameter at the substrate plane (see FIG. 4) is captured at 33 points across the field of the projection lens (3×11 sample regions) with the array of full NA imagers. Light is not captured continuously across the entire field, but these 33 points (in the described example) offer a sufficient sampling of the field to obtain the desired measurement values. The catadioptric optics of the full NA imagers 122 will have a small central obscuration (e.g. due to the refracting regions 128 in FIGS. 1-8, such that light at an NA of less than about 0.3 (5% of the light, assuming σ=1; the illumination fills the NA of the projection optics) is not fully captured in the final system. This low-NA light is typically not critical to the lithography printing process and is also not especially sensitive to defocus or distortion changes of the projection lens.

As a further example, in a system with a 1.4 NA, a 193 nm light source, and the array of full NA imagers described herein, the light at the intermediate image plane 140 is confined to an NA<0.13. The light at the intermediate image plane is still the base wavelength of 193 nm. The relay optics (e.g. 142, 144) collect the light from all 33 full NA imagers and transfer the image to the CCD array 130 located off of the substrate stage (see e.g. the CCD 130 location in the illustration of FIG. 6). The fold mirror 144 is used (FIGS. 6 and 7) to fold the optical axis of the relay system to be perpendicular to the optical axis of the projection lens. In this example, the constraints are that any optics located on the substrate stage must be confined to a cylindrical volume roughly 83 mm in diameter and 40 mm in height, and the distance between the last lens on the substrate stage and the first lens off the substrate stage should be at least 475 mm (assuming 450 mm diameter substrates). Finally, a magnification of −0.5 is incorporated into the relay system to reduce the size of the required CCD to roughly 13 mm×2.5 mm. This system configuration means that no cables are needed with the substrate stage to support the system. Since the CCD 130 is located off the substrate stage, its heat generation is much less of an issue. Also, there are no fluorescent materials involved.

The full NA imaging concept of the present invention is also useful because the imaging requirements are not very stringent. For example, each of the catadioptric full NA imagers can resolve 4 regions within the 162 um field 133 (FIG. 4), if the 4 regions are separated by roughly 60 um. The relay system is good enough to keep the set of 4 points from each of 33 imagers separated, so that the information measured by the CCD is 4*33=132 irradiance values.

Some devices and methods developed by others for converting distortion and focus information into relative irradiance at the substrate plane (e.g. the blinker concept underlying the blinker arrays 134) can be used with the optical components of the present invention. For example, distortion in the x direction is measured by having a series of slits at the reticle plane, each one corresponding to a ‘blinker’ at the substrate plane. The array of blinkers 134 (FIG. 4) is used in the ‘left’ orientation and another array of blinkers is oriented in the ‘right’ orientation. By comparing the amount of light through each array, the distortion can be measured. Since others have demonstrated a high level of accuracy with a technique using fluorescent materials and FOP's on a dry tool, the basic measurement technique will be sensitive enough for focus measurement as well. Placing only right blinkers in 1 of the 4 regions resolved by the catadioptric full NA imagers, and only left blinkers in another, allows for the measurement of distortion. Four regions allow for measurement of x distortion (left, right blinker sets) and y-distortion (up, down blinker sets). The key to using an optical system according to the present invention is that the measurement information required is converted into irradiance at the substrate plane, severely reducing the resolution requirements of the relay system.

Another advantage of the optical system of the present invention is its size. The array of catadioptric full NA imagers and the relay lens elements can be fit within the required volume available on the stage 107. Since the field required of the relay system is not rotationally symmetric, those components can be cut such that they fit in a small volume.

Another advantage of this invention is that multiple copies of the same pattern can be repeated within one of the quadrants of the catadioptric full NA imager array. This means the signal can be amplified by adding many measurements in parallel within a single full NA imager.

FIG. 7 also shows (schematically) how multiple arrays 120 of full NA imagers, each measuring the entire projection lens field, can use the same relay system. One array of the full NA imagers (e.g. schematically shown at 180) can be used for distortion, for example, and another array (e.g. schematically shown at 182) can be used for focus. The distance between the substrate stage and the CCD side optics must be able to change, and in the example described above, for 1.4 NA imaging, moving +/−2.5 mm is not a problem in terms of resolving the different regions.

Measuring wavefront aberration is also possible. Using specially designed pairs of patterns (one pattern at the reticle, and the other at the substrate plane) that are sensitive to certain aberrations, such as different Zernike coefficients, would allow for fast characterization of aberrations. This should work best measuring a subset of aberration coefficients that are most critical and likely to change due to lens heating, for example. This would likely not replace a full wavefront measurement system, but act as a faster system for backup or for measuring certain critical aberrations.

Thus, the optical components of the present invention are configured to capture the full NA light from a discrete set of points that cover the full field of the projection lens, which is exactly the type of measurement information that is required to monitor the state of the projection lens on the imaging tool (also known as a scanner). The optical components of the present invention essentially comprises two important stages; the first is an array of full NA imagers that converts the high NA, small field regions to small NA, larger images, and the second is a relay system that sends this information through air (a span of 475 mm or more) to the second half of the relay and a CCD off the substrate stage. By capturing the full NA (except for a small obscuration of low NA light), all the critical information is obtained. The full field nature means the entire field is captured quickly. Since the measurement system is located at the substrate side, it is capturing the information about the lens in the as-used configuration. The array can be fabricated to mechanically nearly resemble a solid block of glass. The relay system means the CCD (and its wires, cables and cooling fluids) are located away from the substrate stage, eliminating the CCD as a troublesome heat source. The area on the substrate plane that is imaged by the system allows for parallel amplification of the desired signal, instead of just a single slit/slit pair. The entire substrate stage optical assembly fits into the desired region on the corner of the substrate stage. Combining this invention with the existing work (described above) on distortion and focus measurement gives a complete system. This type of an optical system may also work with pattern pair based wavefront aberration measurements.

### Further Comments

The optics of the present invention allows for measuring optical properties of the scanner at the full NA (currently up to 1.40 with a central obscuration) and across the entire field (26 mm×5 mm) at the substrate plane, with (a) no fluorescent materials, (b) no fiber optic plate (FOP), (c) no detector on the substrate stage, and (d) an optical design that fits in the corner of the substrate stage. In addition, properties of the projection lens that can be measured include: (a) distortion, (b) focus, and (c) wavefront aberration. Still further, the optics of the present invention could replace many aspects of a current known aerial image sensor (AIS) system, because it can integrate over many patterns, increasing the optical power throughput, increasing the signal to noise and/or reducing measurement time.

It is further noted that the concepts of distortion measurement blinkers 134 of others are useful with the present invention. The blinkers, are designed to measure distortion, and when paired with lines at the reticle plane, the distortion information is converted to an irradiance measurement at the substrate plane. A set of left blinkers and right blinkers are useful to measure x-distortion, and a set of ‘up’ and ‘down’ blinkers are used to measure y-distortion. Ideally, this blinker method could be used without fluorescent materials (which would have lifetime, immersion problems), FOP (which are subject to 193 nm wavelength problems, and thermal expansion), and with the CCD detector mounted off the stage (eliminating heat and cable issues at the substrate stage).

In the example described above, an array of small field, full NA 1.4 imagers is arranged at the substrate plane. The array is rectangular (FIG. 3) and the diameter of the largest imager is 2.5 mm, allowing three measurement along the y slit dimension and 11 along the x slit dimension (see e.g. FIG. 3). Hexagonal arrays of the imagers could work as well. In addition, each of these 2.5 mm diameter imagers can resolve light from 4 regions, and nothing needs to be resolved within one of these 4 regions, but each region converts the desired information into irradiance. At the substrate plane, a full set of up, down, left and right blinkers, a full set of focus measurements (x, 0°, 180°, and y 0°, 180°), aberration specific patterns (Z1-Z37, for example), and any other pattern that converts the desired information into an irradiance measurement can be employed.

Still further, in the construction of the full NA imagers, as described above in connection with FIG. 7, the curvature of the non-optical region of the first surface of the second component 152 can be matched to the second surface of the first component 150 for easy mechanical assembly. The result is that the two components essentially form a nearly solid cylinder of fused silica. With an array of the full NA imagers that is effectively formed as a single piece of glass, a solid surface is provided at the substrate plane which makes for easier chrome patterning. Also, after coating, the two components are pressed together, making a volume of glass roughly 5 H×7.5 D×27.5 W mm.

The intermediate image plane is relayed to a CCD off the substrate stage, and the relay system is designed to fit in the volume on the corner of the stage 107, and has a minimum separation of 475 mm between the edge of the substrate stage and the relay, relays the full 26 mm×5 mm region, and captures the full NA of the imagers (approximately NA=0.13).

The relay system is rotationally symmetric, but because of the array of NA 1.4 imagers, the field must be larger than sqrt(13̂2+2.5̂2)=13.24 mm in radius. The spots from the corner located optical imagers are about 1 mm farther on the diagonal. For the example described above, the array of imagers is designed to a field radius of 15.75 mm. The magnification of the relay is −0.5, and detector size required is roughly 14 mm×3 mm. Spot sizes have geometrical radius around 115 μm, which is satisfactory.

As described above, one catadioptric array of full NA imagers could be dedicated to measuring distortion, with another array next to it for measuring focus. Although only one array of imagers can be located under the projection lens at a given time, they could both use the same relay system. The relay system field would have to be increased slightly to accommodate this. This would require the distance between the substrate stage and the receiving optics to change by about +/−2.5 mm for the two measurements. Since the neighboring irradiance measurements made at the CCD are separated by ˜250 μm, the defocus introduced by a displacement of 2.5 mm hardly changes the image quality. In other words, the substrate stage location can vary in the current design to allow measurements with different full NA imager arrays without reducing the image quality of the regions on the CCD.

Thus, the forgoing description provides novel optical components in a novel configuration designed to capture the full NA light at the substrate plane (with a central obscuration), by capturing light from a plurality of regions in the field of the projection lens (26×5 mm) simultaneously. The novel optical array of imagers fits within a small volume on the corner of the substrate stages, collects the light off the substrate stage (resulting in no cables, or heat generation), and uses no fluorescent materials or FOP (Fiber optic plates). With the present invention, the desired signal is converted into irradiance at the substrate plane, reducing the imaging requirements on the relay optical system.

Accordingly, as seen from the foregoing description, the present invention provides an optical component of a system for measuring projection lens characteristics of an optical imaging system that images onto a substrate. The optical component is characterized in that the optical component comprises an array of full NA imagers located at the substrate plane. Moreover, another aspect of the present invention provides additional optics for imaging the output of the array of imagers to a detector located remote from the substrate stage. The additional optics image the output of the array of imagers to a detector that is remote from the substrate. With the foregoing disclosure in mind, the manner in which the principles of the present invention can be used to measure various projection lens characteristics will be apparent to those in the art.

1. An optical component of a system for measuring projection lens characteristics of an optical imaging system that images a substrate, characterized in that the optical component comprises an array of two or more full NA imagers located at the substrate plane.

2. The optical component of claim 1, wherein each of the full NA imagers has a catadioptric optical configuration.

3. The optical component of claim 1, wherein each of the full NA imagers comprises a catadioptric optical portion with a pair of reflecting regions and a refracting region.

4. The optical component of claim 3, wherein each of the full NA imagers comprises a reflecting region that has a predetermined curvature and a refracting region having a transmissive portion with a curvature with an opposite direction to the curvature of the reflecting region.

5. The optical component of claim 4, wherein the refracting region is located at the center of the curved reflecting region.

6. The optical component of claim 3, wherein each of the full NA imagers comprises a refracting region configured to refract and transmit light below a predetermined threshold angle of incidence.

7. The optical component of claim 6, wherein each of the full NA imagers further comprises a relatively flat reflecting region that faces the curved reflecting surface, and where the curvature of the curved reflecting region and the orientation of the curved and relatively flat reflecting regions are configured to produce reflection of light rays above a first predetermined threshold angle of incidence, and reflect the light rays in a manner that produces reflected light rays that are directed to the refracting region at angles of incidence below the threshold angle of incidence referenced in claim 6, so that such light rays are refracted and transmitted by the refracting region.

8. The optical component of claim 7, wherein the threshold angle of incidence that is referenced in claim 6 is taken relative to a surface normal to the refracting region and is lower than the first threshold angle of incidence.

9. The optical component of claim 6, wherein the curved reflecting region comprises a reflective portion of a continuous curved surface, and the refracting region comprises a refracting portion of the continuous curved surface.

10. The optical component of claim 9, wherein the continuous curved surface has a surface coating that reflects light incident above the first threshold angle of incidence and produces the curved reflecting region, and refracts and transmits light at below the second threshold angle of incidence, to produce the refracting region.

11. The optical component of claim 3, wherein the optical imagers are arranged in a predetermined configuration at the substrate plane.

12. The optical component of claim 10, wherein each of the array of the full NA imagers is cylindrical and the array of full NA imagers are in a configuration in which the centers of the cylindrical imagers form a rectangle of about 26 mm by 5 mm.

13. Optical components for use in measuring projection lens characteristics of an optical imaging system that images a substrate, comprising an array of full NA imagers located at the substrate plane, and additional optics for imaging the array of imagers to a detector located remote from the substrate.

14. The optical components of claim 12, wherein the additional optics are configured to image the array of full NA imagers to an intermediate plane, and a relay system images the intermediate plane to a detector that is remote from the substrate.

15. The optical components of claim 13, wherein each of the full NA imagers has a catadioptric optical configuration.

16. The optical components of claim 13, wherein each of the full NA imagers comprises a catadioptric optical portion with a pair of reflecting regions and a refracting region.

17. The optical components of claim 16, wherein each of the full NA imagers comprises a reflecting region that has a predetermined curvature and a refracting region with a transmissive refractive portion having a curvature with an opposite direction to the curvature of the reflecting region.

18. The optical components of claim 16, wherein the refracting region is located at the center of the curved reflecting surface.

19. The optical components of claim 15, wherein each of the full NA imagers comprises a refracting region configured to refract and transmit light below a predetermined threshold angle of incidence.

20. The optical components of claim 18, wherein each of the full NA imagers further comprises a relatively flat reflecting region that faces the curved reflecting region, and where the curvature of the curved reflecting region and the orientation of the curved and relatively flat reflecting regions are configured to produce reflection of light rays above a predetermined first threshold angle of incidence, and reflect the light rays in a manner that produces reflected light rays that are directed to the refracting region at angles of incidence below the predetermined threshold angle of incidence referenced in claim 6, so that such light rays are refracted and transmitted by the refracting region.

21. The optical components of claim 20, wherein the threshold angle of incidence referenced in claim 20 is taken relative to a surface normal to the refracting region and is lower than the first threshold angle of incidence.

22. The optical components of claim 19, wherein the curved reflecting region comprises a reflective portion of a continuous curved surface, and the refracting portion comprises a refracting portion of the continuous curved surface.

23. The optical components of claim 20, wherein the continuous curved surface has a surface coating that reflects light incident above the first threshold angle of incidence, and has a refracting region that refracts and transmits light incident below the threshold predetermined angle of incidence referenced in claim 20.

24. The optical components of claim 15, wherein the optical imagers are arranged in a predetermined configuration at the substrate plane.

25. The optical components of claim 24, wherein each of the array of the full NA imagers is cylindrical and the array of full NA imagers are in a configuration in which the centers of the cylindrical imagers form a rectangle of about 26 mm by 5 mm.
